(19) United States
(12) Patent Application Publication
(10) Pub. No.: US 2011/0277699 A1
(43) Pub. Date: Nov. 17, 2011

(54) Universal dog hitch for pulling, exercising and recreating

(76) Inventors: Patricia McCarthy, Guilford, VT (US); Colin Twitchell, Guilford, VT (US)

(21) Appl. No.: 12/800,383

(22) Filed: May 17, 2010

(51) Int. Cl. A01K 27/00

(52) U.S. Cl. 119/771

(57) ABSTRACT

This invention is designed for a person⁶ to interact⁷ with their dog⁸, or other animal, as a companion with the dog(s)⁹ pulling the vehicle at the dog's pace, with the dog in harness and still on a leash¹⁰. This allows the driver to maintain control of the dog at all times, including while the dog is pulling the vehicle at a walk, trot or run which would exceed most human's walking and running speed therefore giving the dog more freedom and exercise. This invention may also be used as a means to control a dog even when not pulling. ⁶ A person also denotes a “driver, owner, rider, trainer, handler, competitor, traveler' and the like.⁷ Interact also includes “recreate, exercise, compete, train, rehabilitate, transport, drafting” or the like.⁸ Dog as a singular will be used although more than one dog may be included.⁹ “Dog” is referred to here and includes any animal (such as horse, ox, goat or other) that may be used to pull a vehicle.¹⁰ The term “leash” will be used throughout and includes any line flexible, static, retractable or not that is used to attach the dog and harness to the vehicle.

### CROSS-REFERENCE TO RELATED APPLICATIONS

This application claims the benefit of PPA Ser. No. 61/216,190 filed May 14, 2009 by the present inventors, which is incorporated by reference.

### FEDERALLY SPONSORED RESEARCH

Not applicable

### SEQUENCE LISTING OR PROGRAM

Not applicable

### BACKGROUND AND SUMMARY OF THE INVENTION

1. Field of Invention

This invention generally relates to any dog/animal that needs to exercise and is best served when pulling. Sporting and working animals need to pull and to run at full speed in order to keep their stamina and health. Dogs and other animals are typically exercised by their owners through the act of walking or running. However, walking and running may not provide sufficient exercise for some dogs, especially those of the sporting and working breeds. Bicycling, mountain scooters and tikes have become increasingly popular for exercise as people age. Many people are combining their exercise with exercising their dogs (or other animals). In prior practice, this was done by the person riding a bicycle while holding onto a leash or tying the leash to the handlebars. These two methods were dangerous as the bike and rider could easily be pulled off balance.

There have been numerous attempts to design a tethering device to exercise a dog which eliminates the need for tying to the handlebars or steering rod.

From the above it is apparent that there exists a need for a device which allows a dog (animal) to pull a small vehicle from the front and run at full speed. It is therefore a principal object of the present invention to provide such a device; an apparatus that mounts to a small vehicle such as a bicycle or scooter, is attached to a dog and pulled by a dog, minimizing interference with the wheels or skis, and maintaining control of the vehicle and animal. It is another object of the present invention to isolate and attenuate motion and energy between the dog and bicycle to prevent instability caused by sudden motions of the vehicle or dog. In this embodiment, the dog can pull approximately 160 degrees from the right side, to directly in front and to the left side.

2. Prior Art

Prior designs have been focused solely on bicycles and are mounted to the seat post, rear axle and from the side. These designs allow the dog to exercise only at the riders pace, not at the dogs pace. When the dog is leashed to the bicycle in this fashion, the rider cannot see they dog and cannot maintain control as easily. Designs with the attachments to the side would cause interference with other riders on a bike way and do not allow the rider and dog to easily use a single track trail. Most of these designs are considered “pet restraints” as they limit the speed of the dog. One device that attaches the dog to the front by Barbour, U.S. Pat. No. 5,842,445, only allows the dog to pull from a directly forward position. If the dog is off to the side at all, they have no ability to achieve forward propulsion of the vehicle. Another device that could be attached in the front by Allred, U.S. Pat. No. 5,215,037, would ultimately interfere with the brake cables and may not have the stability and strength to allow the dog to pull up to 160 degrees.

### RELEVANT PRIOR ART

U.S. Pat. No. 4,134,364 January 1979 Boncela
U.S. Pat. No. 4,854,269 August 1989 Arntzen
U.S. Pat. No. 5,033,409 July 1991 Sabot
U.S. Pat. No. 5,215,037 June 1993 Allred
U.S. Pat. No. 5,375,561 November 1993 Gundersen
U.S. Pat. No. 5,842,445 December 1998 Barbour
U.S. Pat. No. 6,135,059 October 2000 Brock
U.S. Pat. No. 6,148,772 September 1998 Keyek-Frannsen

### SUMMARY

In accordance with one embodiment, a dog can propel a small vehicle at their pace and at an extended run. With this present embodiment; the dog's leash is attached through the swing arm which rotates approximately 160 degrees allowing for maximum pulling. The increased interest of exercising dogs at their pace has led to the creation of a new sport called “urban mushing” which is only one avenue of use.

### DRAWINGS

### Figures

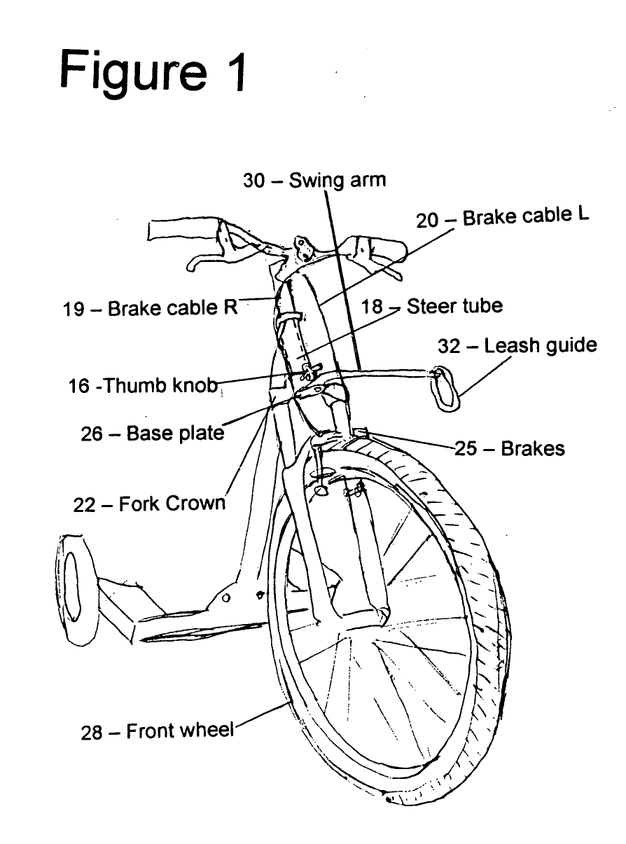

FIG. 1—is a full view of the mount assembly attached to the steer tube of a scooter with the swing arm attached and showing the general features.

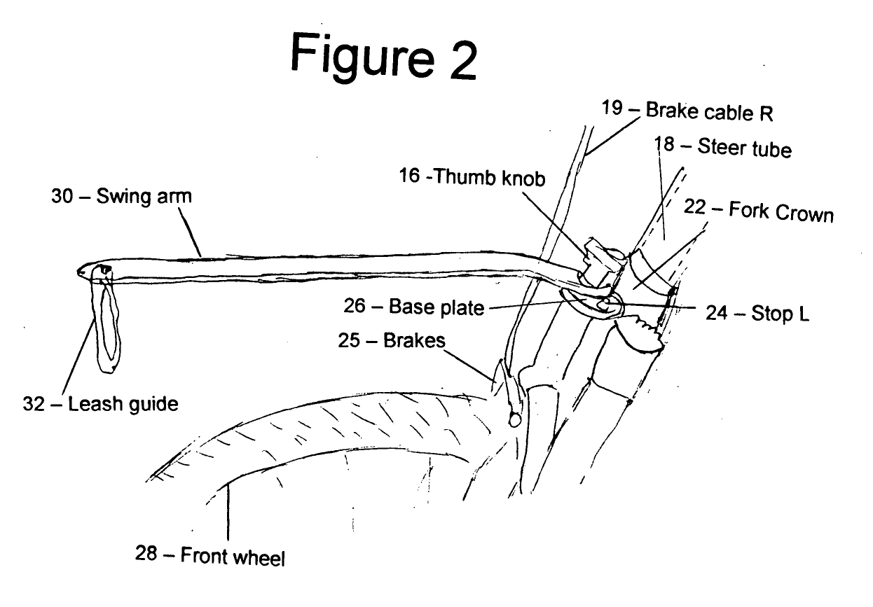

FIG. 2—is a dose-up view of the mount assembly with the swing arm attached and a stop on the left side.

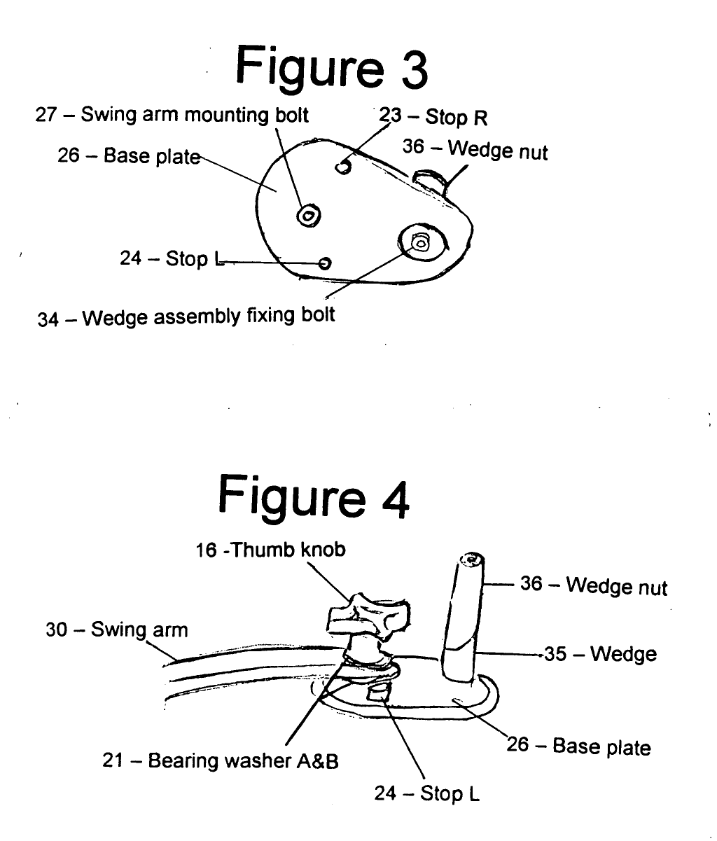

FIG. 3—is a bottom view of the base plate

FIG. 4—is a close-up view of the mount assembly unattached from scooter with the swing arm

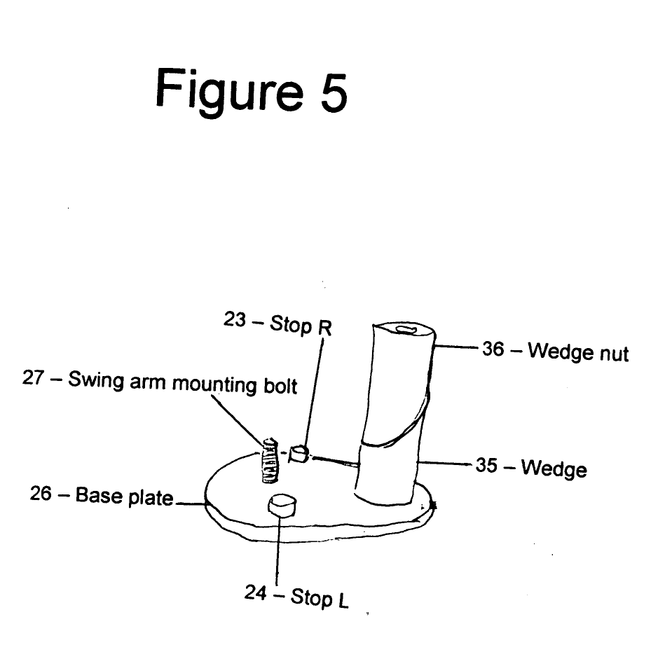

FIG. 5—is a close-up view of the mount assembly unattached from scooter without the swing arm

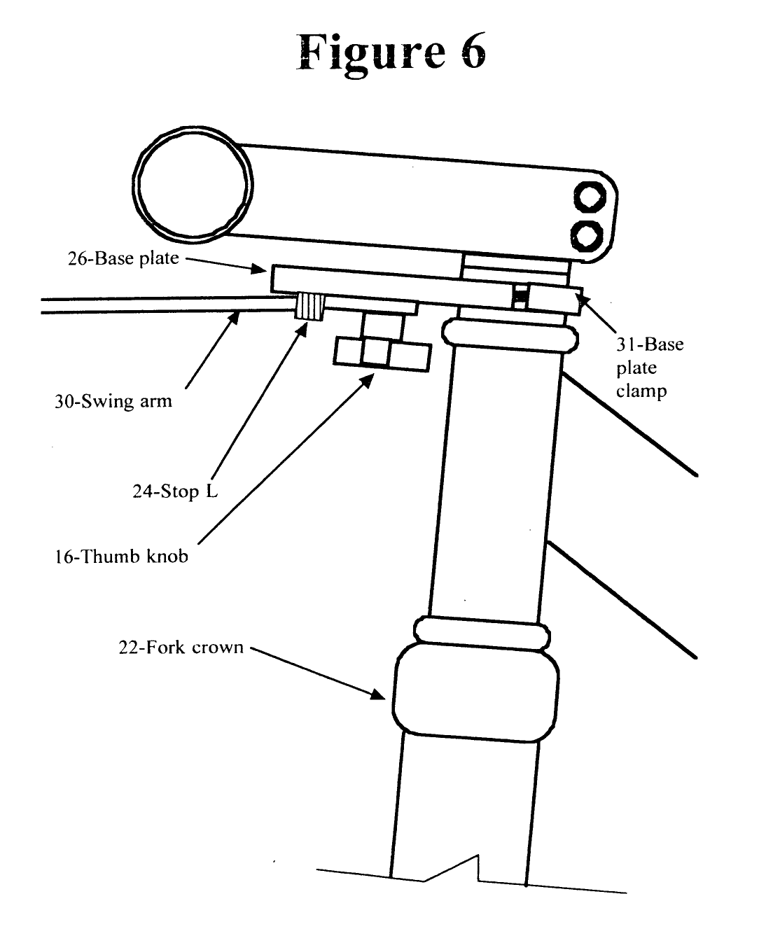

FIG. 6—is a side view of alternative damping system

### DRAWINGS

### Reference Numerals

16—Thumb knob
18—Steer tube
19—Brake cable R
20—Brake cable L
21—Bearing washer MB
22—Fork Crown
23—Stop R
24—Stop L
25—Brakes
26—Base plate
27—Swing arm mounting bolt
28—Front wheel
30—Swing arm
31—Base plate clamp
32—Leash guide
34—Wedge assembly fixing bolt
35—Wedge
36—Wedge nut

### DETAILED DESCRIPTION

### First Embodiment

### FIGS. 1-5

The Universal Dog Hitch achieves its' results in various ways, depending upon the type of vehicle and fork, as described below. A wedge and wedge nut¹ protrudes vertically off of a base plate, together called the mount assembly, and inserts into the steer tube² of the fork with the base plate to the front of the vehicle. The head of the swing arm is then attached to the base plate with an easy to tighten and removable thumb knob³. The leash is then attached to the vehicle and thread through a Leash guide⁴ on the distal end of the swing arm and attached to the harness on the dog. If a retractable leash is used, the handle of the leash may be attached to the center of the handle bars or head set with a secure material⁵; the leash is then threaded through the Leash guide at the distal end of the swing arm and then attached to the dogs' harness. If a static leash is used, it may be either attached as the retractable leash on the handle bars or attached directly to the distal end of the swing arm, furthest from vehicle, and then to the dog's harness. The vehicle and driver are then pulled forward by the dog at various speeds. ¹ Any type of nut or bolt that keeps the stem in place can be used.² Refers to the steer tube on a bicycle but can be any none rotating part on the front of other vehicles.³ The bolt may be any device that secures the swing arm and still allows it to move.⁴ Leash Guide is generic to mean any secure device (opening or not) and made of a variety of materials whether metal, cloth or other. Examples include carabiner, rapid link, clip, ring, eye bolt etc., this list is not all inclusive.⁵ Any material that secures the leash can be used, examples are; webbing, a clamp, leather strap or other material or component, this list in not all inclusive.

### Operation

### First Embodiment

The leash guide 32 is connected to the swing arm 30 via a hole in the distal end of the swing arm 30. The swing arm 30 is held captive to the base plate 26 on its nearer end with the swing arm mounting bolt 27, two bearing washers 21 A&B, and a thumb knob 16. One bearing washer 21B is directly on the base plate and the other bearing washer 21A is between the swing arm 30 and the thumb knob 16. This places the swing arm 30 extending forward off of the base plate 26 and fork crown 22. There are two stops 23 & 24 affixed to both sides of the base plate 26 which set boundaries for the swing arm 30.

The wedge 35 is permanently secured to the base plate 26. The wedge assembly fixing bolt 34 goes through a hole in the base plate 26 closest to the fork crown 22, goes through the wedge 35 and threads into the wedge nut 36. The wedge 35 and wedge nut 36 protrude vertically from the base plate 26 and inserts inside the steer tube 18. The wedge 35, wedge nut 36, wedge assembly fixing bolt 34 and the base plate 26 comprises the components of what is being called the mounting assembly.

### Description

### Alternative Embodiment

### FIG. 6

The base plate 26 clamps around the upper part of the steer tube 18 between the upper headset bearing and the stem.

### CONCLUSION, RAMIFICATIONS, AND SCOPE

Accordingly the reader will see that, according to one embodiment of the invention, I have provided, a dog or other animal would be able to propel a small vehicle at a variety of speeds and degrees. While the above description contains many specificities, these should not be construed as limitations on the scope of any embodiment, but as exemplifications of the presently preferred embodiments thereof. Many other ramifications and variations are possible within the teachings of the various embodiments. For example, the base plate can be attached with a clamp to the outside of the frame of the vehicle.

Thus the scope of the invention should be determined by the appended claims and their legal equivalents, and not by the examples given.

### ADVANTAGES

1. One advantage of the Universal Dog Hitch is that while the dog is pulling, they may run, trot, or walk at their pace for optimum exercise while the driver helps by pedaling, scootering, walking or pushing as needed. With a higher level of exercise the dog can either stay in shape or lose weight. In addition, depending upon the vehicle used, the person may also get exercise. Referencing Claims #1.
2. A key advantage is the position of the swing arm which vastly reduces the chances of the leash wrapping around the front wheel(s) when the vehicle is in motion which could cause a sudden stop and possible fall for the driver. Referencing Claim #2.
3. The stops on the base plate are designed to prohibit the swing arm from interfering with the front forks, brake or other cables. Referencing Claim #2.
4. The position of the swing arm and therefore the dog is an advantage as the person can keep their dog in view without having to look to their side or behind. Referencing Claim #2.
5. The dog can move freely from one side to the other while the swing arm follows the dog and allows the driver time to respond without pulling the vehicle off balance. Referencing Claim #3.
6. The strength and placement of this embodiment allows for entry into competitive events such as the new sport of “Urban Mushing”. Referencing Claim #3.
7. Allows the dog to be quickly attached to the vehicle without interference for the person.
8. The swing arm can be easily removed.
9. The mount assembly may remain on the vehicle for use with, a basket or other accessories when the swing arm is not in use.

### SEQUENCE LISTING

Not applicable

### Alternative Ways to Achieve Results:

1. Another style is having the bracket bolt to the fork crown with the base plate attached to it for the swing arm.
2. Depending upon the vehicle, the mount assembly can be clamped to the fork blades with a base plate for the swing arm.
3. Different components, sizes and materials may be used for any components.
4. A mount assembly may be fixed to the outside of the vehicles' steer tube or any non-rotating part of the vehicle.
5. The bracket and base plate may be separate components or welded together.
6. The base plate can be any design that supports the swing arm.
7. The Leash, which is the attachment used at the distal end of the swing arm to guide the leash, can be a carabiner, rapid link, closed device, rotating eye bolt, stationary eye bolt, ring or other enclosure and made of a variety of materials.
8. The Leash Guide at the distal end of the swing arm may be free or be stationary.
9. The Leash Guide at the distal end of the swing arm may be a part of the swing arm or a separate component.
10. The swing arm may be flat or have an inclined plane.
11. The leash used to attach the animal to the vehicle may be made of a variety of materials that are either static or flexible.
12. The leash may be a retractable, static or flexible.

1-16. (canceled)

17. In this embodiment, the dog provides the primary propulsion, pulling the vehicle forward at their pace, whether at a full run, trot or walk, with assistance by the driver as needed.

18. The design of this embodiment provides more vehicle safety and control by allowing the swing arm to elevate the leash above and out of the way of the front wheel(s), the base plate stops keep cable housings from obstructing swing arm, but allow it to safely augment vehicle balance by absorbing multi-directional towing forces.

19. The placement and strength of this embodiment allows for use both on and off road, with more controlled turning of corners and resulting in the ability to reach higher speeds then previous designs.
